(19) United States
(12) Patent Application Publication
(10) Pub. No.: US 2024/0153101 A1
(43) Pub. Date: May 9, 2024

(54) SCENE SYNTHESIS FROM HUMAN MOTION

(71) Applicants: TOYOTA RESEARCH INSTITUTE, INC., Los Altos, CA (US); THE BOARD OF TRUSTEES OF THE LELAND STANFORD JUNIOR UNIVERSITY, Stanford, CA (US)

(72) Inventors: Sifan YE, Stanford, CA (US); Yixing WANG, Stanford, CA (US); Jiaman LI, Stanford, CA (US); Dennis PARK, Fremont, CA (US); C. Karen LIU, Los Altos, CA (US); Huazhe XU, Stanford, CA (US); Jiajun WU, Stanford, CA (US)

(73) Assignees: TOYOTA RESEARCH INSTITUTE, INC., Los Altos, CA (US); THE BOARD OF TRUSTEES OF THE LELAND STANFORD JUNIOR UNIVERSITY, Stanford, CA (US)

(21) Appl. No.: 18/494,598

(22) Filed: Oct. 25, 2023

Related U.S. Application Data
(60) Provisional application No. 63/419,658, filed on Oct. 26, 2022.

(51) Int. Cl. G06T 7/20; G06T 7/70; G06V 20/70

(52) U.S. Cl. CPC G06T 7/20; G06T 7/70; G06V 20/70; G06T 2207/20044; G06T 2207/20081; G06T 2207/30241

(57) ABSTRACT

A method for scene synthesis from human motion is described. The method includes computing three-dimensional (3D) human pose trajectories of human motion in a scene. The method also includes generating contact labels of unseen objects in the scene based on the computing of the 3D human pose trajectories. The method further includes estimating contact points between human body vertices of the 3D human pose trajectories and the contact labels of the unseen objects that are in contact with the human body vertices. The method also includes predicting object placements of the unseen objects in the scene based on the estimated contact points.

### CROSS-REFERENCE TO RELATED APPLICATION

The present application claims the benefit of U.S. Provisional Patent Application No. 63/419,658, filed Oct. 26, 2022, and titled “SCENE SYNTHESIS FROM HUMAN MOTION,” the disclosure of which is expressly incorporated by reference herein in its entirety.

### BACKGROUND

### Field

Certain aspects of the present disclosure relate to machine learning and, more particularly, scene synthesis from human motion.

### Background

Autonomous agents (e.g., vehicles, robots, etc.) rely on machine vision for sensing a surrounding environment by analyzing areas of interest in images of the surrounding environment. Although scientists have spent decades studying the human visual system, a solution for realizing equivalent machine vision remains elusive. Realizing equivalent machine vision is a goal for enabling truly autonomous agents. Machine vision is distinct from the field of digital image processing because of the desire to recover a three-dimensional (3D) structure of the world from images and using the 3D structure for fully understanding a scene. That is, machine vision strives to provide a high-level understanding of a surrounding environment, as performed by the human visual system.

In practice, capturing, modeling, and synthesizing realistic human motion in 3D scenes is important in a spectrum of applications such as virtual reality, game character animation, and human-robot interaction. To facilitate research in this area, a plethora of datasets have been curated to capture human motion. Unfortunately, building high-quality large-scale datasets annotated by both diverse human motions and reconstruction of a wide variety of 3D scenes still remains challenging. A process of leveraging recent advances in modeling 3D human poses and their contacts with environments to synthesize the scenes only from human motion data, is desired.

### SUMMARY

A method for scene synthesis from human motion is described. The method includes computing three-dimensional (3D) human pose trajectories of human motion in a scene. The method also includes generating contact labels of unseen objects in the scene based on the computing of the 3D human pose trajectories. The method further includes estimating contact points between human body vertices of the 3D human pose trajectories and the contact labels of the unseen objects that are in contact with the human body vertices. The method also includes predicting object placements of the unseen objects in the scene based on the estimated contact points.

A system for scene synthesis from human motion is described. The system includes a pose trajectory module to compute three-dimensional (3D) pose trajectories of human motion. The system also includes a prediction module for a human-scene contact and scene synthesis, configured to predict a feasible object placement in a scene based on the computed 3D pose trajectories of human motion.

A non-transitory computer-readable medium having program code recorded thereon for scene synthesis from human motion is described. The program code is executed by a processor. The non-transitory computer-readable medium includes program code to compute three-dimensional (3D) human pose trajectories of human motion in a scene. The non-transitory computer-readable medium also includes program code to generate contact labels of unseen objects in the scene based on the computing of the 3D human pose trajectories. The non-transitory computer-readable medium further includes program code to estimate contact points between human body vertices of the 3D human pose trajectories and the contact labels of the unseen objects that are in contact with the human body vertices. The non-transitory computer-readable medium also includes program code to predict object placements of the unseen objects in the scene based on the estimated contact points.

A system for scene synthesis from human motion is described. The system includes a three-dimensional (3D) human pose trajectory module to compute 3D human pose trajectories of human motion in a scene The system also includes a contact label generation module to generate contact labels of unseen objects in the scene based on the computing of the 3D human pose trajectories. The system further includes a contact point estimation module to estimate contact points between human body vertices of the 3D human pose trajectories and the contact labels of the unseen objects that are in contact with the human body vertices. The system also includes a 3D object placement module to predict object placements of the unseen objects in the scene based on the estimated contact points.

This has outlined, broadly, the features and technical advantages of the present disclosure in order that the detailed description that follows may be better understood. Additional features and advantages of the present disclosure will be described below. It should be appreciated by those skilled in the art that the present disclosure may be readily utilized as a basis for modifying or designing other structures for conducting the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a system using a system-on-a-chip (SOC) for scene synthesis from human motion, in accordance with aspects of the present disclosure.

FIG. 2 is a block diagram illustrating a software architecture that may modularize functions for scene synthesis from human motion, according to aspects of the present disclosure.

FIG. 3 is a diagram illustrating an example of a hardware implementation for a scene synthesis from human motion system, according to aspects of the present disclosure.

FIGS. 4A-4F illustrate a scene synthesis from human motion (SUMMON) process performed using solely human motion, according to aspects of the present disclosure.

FIG. 5 is a block diagram of a contact former architecture for the scene synthesis from human motion system of FIG. 4B, according to aspects of the present disclosure.

FIG. 6 is a diagram illustrating majority voting to enable scene synthesis from human motion, according to aspects of the present disclosure.

FIGS. 7A-7C illustrate a scene synthesis using the scene synthesis from human motion (SUMMON) process of FIGS. 4A-4F and the contact former architecture of FIG. 5, according to aspects of the present disclosure.

FIG. 8 is a flowchart illustrating a method for scene synthesis from human motion, according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure disclosed may be embodied by one or more elements of a claim.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be universally applicable to different technologies, system configurations, networks, and protocols, some of which are illustrated by way of example in the figures and in the following description of the preferred aspects. The detailed description and drawings are merely illustrative of the present disclosure, rather than limiting the scope of the present disclosure being defined by the appended claims and equivalents thereof.

Deploying autonomous agents in diverse, unstructured environments involves robots that operate with robust and general behaviors. Enabling general behaviors in complex environments, such as a home, involves autonomous agents with the capability to perceive and manipulate previously unseen objects, such as new glass cups or t-shirts, even in the presence of variations in lighting, furniture, and objects. A promising approach to enable robust, generalized behaviors is to procedurally generate and automatically label large-scale datasets in simulation and use these datasets to train perception models.

Capturing, modeling, and synthesizing realistic human motion in 3D scenes is important in a spectrum of applications such as virtual reality, game character animation, and human-robot interaction. To facilitate research in this area, a plethora of datasets have been curated to capture human motion. For example, collections of trajectories of human manipulating objects as well as datasets containing human contact with a scene mesh with object class labels are available. Nevertheless, building high-quality large-scale datasets annotated by both diverse human motions and reconstruction of a wide variety of 3D scenes still remains challenging. This is mainly because such data is captured in laboratory settings, which entails limited physical space and costly devices, such as motion capture systems, structure cameras, and a 3D scan system. A process of leveraging recent advances in modeling 3D human poses and their contacts with environments to synthesize the scenes from human motion data, is desired.

Various aspects of the present disclosure are directed to scene synthesis from human motion (SUMMON) and, in particular, a system and method that predicts feasible object placements in a scene based solely on 3D human pose trajectories. In various aspects of the present disclosure a SUMMON system is composed of two modules: a human-scene contact prediction module and a scene synthesis module. The human-scene contact module may leverage existing human-scene interaction (HSI) data to learn an object model for mapping from human body vertices to the semantic label of the objects that are in contact. Some aspects of the present disclosure incorporate temporal cues to enhance the consistency in label prediction in time. For example, given the estimated semantic contact points, the object i module first searches for objects that fit the contact points in the scene in terms of semantics and physical affordances to the agent; it then populates the scene with other objects that have no contact with humans, based on human motion and objects inferred from previous steps.

Some aspects of the present disclosure consider temporal information using a contact former model, which is configured as a contact model that learns to predict contact information and outperforms conventional prediction methods. After obtaining this model, objects in the room are synthesized. These aspects of the present disclosure provide a method that qualitatively shows realistic, physically plausible, and diverse scenes. We also show large advantages quantitatively against baselines in the generation quality, using various metrics and human evaluation. These aspects of the present disclosure involve SUMMON, which is configured for synthesizing semantically reasonable, physically plausible, and diverse scenes based only on human motion trajectories. Additionally, as a part of SUMMON, a contact prediction module is provided that outperforms existing methods by modeling the temporal consistency in semantic labels. Beneficially, scenes synthesized by SUMMON consistently outperform existing methods both qualitatively and quantitatively.

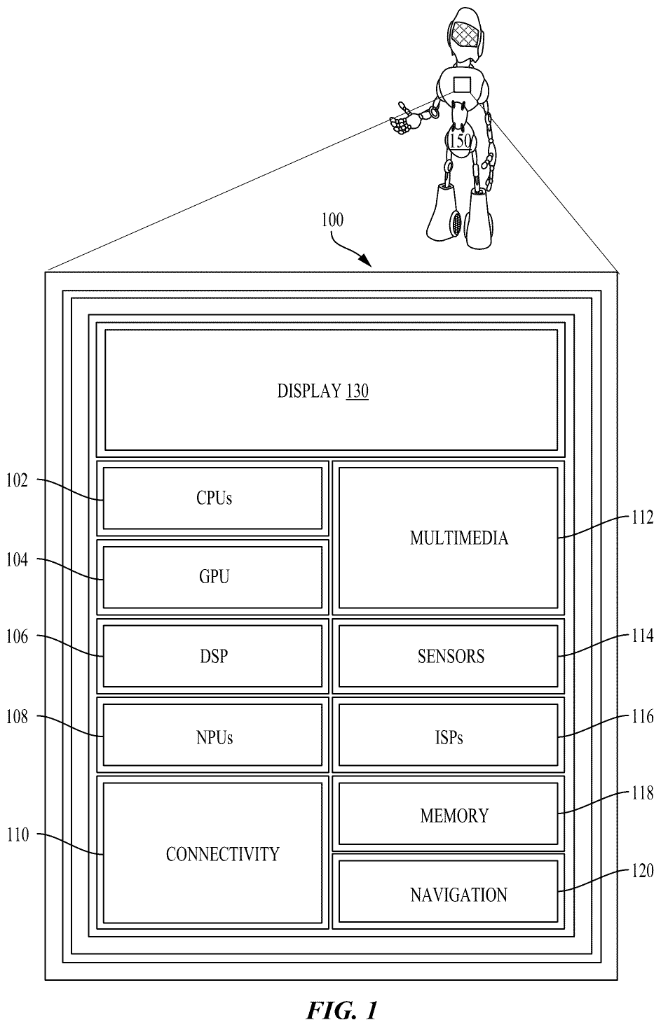

FIG. 1 illustrates an example implementation of the aforementioned system and method for scene synthesis from human motion using a system-on-a-chip (SOC) 100 of a robot 150. The SOC 100 may include a single processor or multi-core processors (e.g., a central processing unit), in accordance with certain aspects of the present disclosure. Variables (e.g., neural signals and synaptic weights), system parameters associated with a computational device (e.g., neural network with weights), delays, frequency bin information, and task information may be stored in a memory block. The memory block may be associated with a neural processing unit (NPU) 108, a CPU 102, a graphics processing unit (GPU) 104, a digital signal processor (DSP) 106, a dedicated memory block 118, or may be distributed across multiple blocks. Instructions executed at a processor (e.g., CPU 102) may be loaded from a program memory associated with the CPU 102 or may be loaded from the dedicated memory block 118.

The SOC 100 may also include additional processing blocks configured to perform specific functions, such as the GPU 104, the DSP 106, and a connectivity block 110, which may include fourth generation long term evolution (4G LTE) connectivity, unlicensed Wi-Fi connectivity, USB connectivity, Bluetooth® connectivity, and the like. In addition, a multimedia processor 112 in combination with a display 130 may, for example, classify and categorize poses of objects in an area of interest, according to the display 130 illustrating a view of a robot. In some aspects, the NPU 108 may be implemented in the CPU 102, DSP 106, and/or GPU 104. The SOC 100 may further include a sensor processor 114, image signal processors (ISPs) 116, and/or navigation 120, which may, for instance, include a global positioning system.

The SOC 100 may be based on an Advanced Risk Machine (ARM) instruction set or the like. In another aspect of the present disclosure, the SOC 100 may be a server computer in communication with the robot 150. In this arrangement, the robot 150 may include a processor and other features of the SOC 100. In this aspect of the present disclosure, instructions loaded into a processor (e.g., CPU 102) or the NPU 108 of the robot 150 may include code for scene synthesis from human motion within an image captured by the sensor processor 114. The instructions loaded into a processor (e.g., CPU 102) may also include code for planning and control (e.g., of the robot 150) in response to scene synthesis from human motion within an image captured by the sensor processor 114.

The instructions loaded into a processor (e.g., CPU 102) may also include code to compute three-dimensional (3D) human pose trajectories of human motion in a scene. The instructions loaded into a processor (e.g., CPU 102) may also include code to obtain contact labels of unseen objects in the scene based on the computing of the 3D human pose trajectories. The instructions loaded into a processor (e.g., CPU 102) may further include code to estimate contact points between human body vertices of the 3D human pose trajectories and the contact labels of the unseen objects that are in contact with the human body vertices. The instructions loaded into a processor (e.g., CPU 102) may also include code to predict object placements of the unseen objects in the scene based on the estimated contact points.

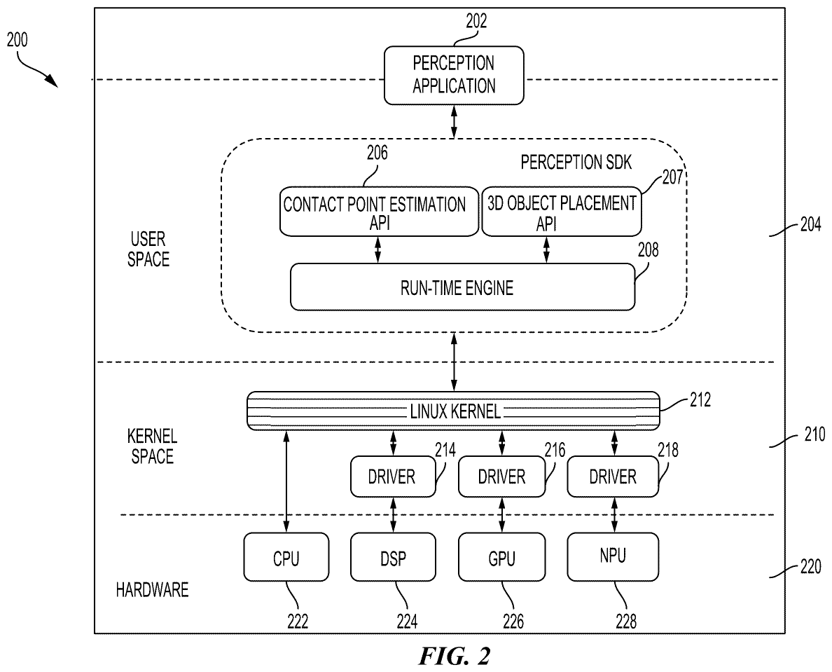

FIG. 2 is a block diagram illustrating a software architecture 200 that may modularize functions for scene synthesis from human motion, according to aspects of the present disclosure. Using the architecture, a perception application 202 may be designed such that it may cause various processing blocks of an SOC 220 (for example a CPU 222, a DSP 224, a GPU 226, and/or an NPU 228) to perform supporting computations during run-time operation of the perception application 202.

The perception application 202 may be configured to call functions defined in a user space 204 that may, for example, synthesize a scene in a video captured by a monocular camera of a robot based on human motion for object placement in the scene based on computed 3D pose trajectories of human motion. In aspects of the present disclosure, placement of unknown objects in a scene of a video is improved by estimating contact points between computed 3D pose trajectories of human motion and the unknown objects. The perception application 202 may make a request to compile program code associated with a library defined in a contact point estimation application programming interface (API) 206. In various aspects of the present disclosure, the contact point estimation API 206 is configured to obtain contact labels of unseen objects in the scene based on computing of 3D human pose trajectories. The contact point estimation API 206 may estimate contact points between human body vertices of the 3D human pose trajectories and the contact labels of the unseen objects that are in contact with the human body vertices. Additionally, a 3D object placement API 207 may perform object placements of the unseen objects in the scene based on the estimated contact points.

A run-time engine 208, which may be compiled code of a run-time framework, may be further accessible to the perception application 202. The perception application 202 may cause the run-time engine 208, for example, to scene synthesis from human motion. When an object placement is detected within a predetermined distance of the robot, the run-time engine 208 may in turn send a signal to an operating system 210, such as a Linux Kernel 212, running on the SOC 220. The operating system 210, in turn, may cause a computation to be performed on the CPU 222, the DSP 224, the GPU 226, the NPU 228, or some combination thereof. The CPU 222 may be accessed directly by the operating system 210, and other processing blocks may be accessed through a driver, such as drivers 214-218 for the DSP 224, for the GPU 226, or for the NPU 228. In the illustrated example, the deep neural network may be configured to run on a combination of processing blocks, such as the CPU 222 and the GPU 226, or may be run on the NPU 228, if present.

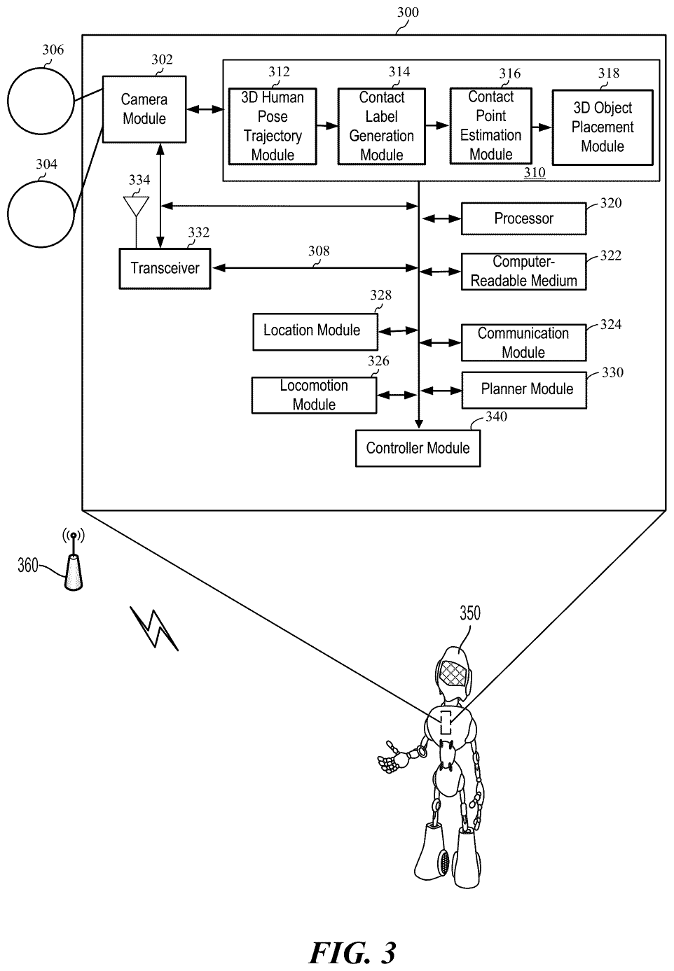

FIG. 3 is a diagram illustrating an example of a hardware implementation for a scene synthesis from human motion system 300, according to aspects of the present disclosure. The scene synthesis from human motion system 300 may be configured for understanding a scene to enable planning and controlling a robot in response to images from video captured through a camera during operation of a robot 350. The scene synthesis from human motion system 300 may be a component of a robotic or other autonomous device. For example, as shown in FIG. 3, the scene synthesis from human motion system 300 is a component of the robot 350. Aspects of the present disclosure are not limited to the scene synthesis from human motion system 300 being a component of the robot 350, as other devices, such as a vehicle, a bus, a motorcycle, or other like autonomous vehicles, are also contemplated for using the scene synthesis from human motion system 300. The robot 350 may be autonomous or semi-autonomous.

The scene synthesis from human motion system 300 may be implemented with an interconnected architecture, such as a controller area network (CAN) bus, represented by an interconnect 308. The interconnect 308 may include any number of point-to-point interconnects, buses, and/or bridges depending on the specific application of the scene synthesis from human motion system 300 and the overall design constraints of the robot 350. The interconnect 308 links together various circuits, including one or more processors and/or hardware modules, represented by a camera module 302, a robot perception module 310, a processor 320, a computer-readable medium 322, a communication module 324, a locomotion module 326, a location module 328, a planner module 330, and a controller module 340. The interconnect 308 may also link various other circuits such as timing sources, peripherals, voltage regulators, and power management circuits, which are well known in the art, and therefore, will not be described any further.

The scene synthesis from human motion system 300 includes a transceiver 332 coupled to the camera module 302, the robot perception module 310, the processor 320, the computer-readable medium 322, the communication module 324, the locomotion module 326, the location module 328, a planner module 330, and the controller module 340. The transceiver 332 is coupled to an antenna 334. The transceiver 332 communicates with various other devices over a transmission medium. For example, the transceiver 332 may receive commands via transmissions from a user or a remote device. As discussed herein, the user may be in a location that is remote from the location of the robot 350. As another example, the transceiver 332 may transmit placed objects within an image from a video and/or planned actions from the robot perception module 310 to a server (not shown).

The scene synthesis from human motion system 300 includes the processor 320 coupled to the computer-readable medium 322. The processor 320 performs processing, including the execution of software stored on the computer-readable medium 322 to provide scene synthesis functionality, according to the present disclosure. The software, when executed by the processor 320, causes the scene synthesis from human motion system 300 to perform the various functions described for robotic perception of objects in scenes based on objects placements within a scene of video captured by a camera of an autonomous agent, such as the robot 350, or any of the modules (e.g., 302, 310, 324, 326, 328, 330, and/or 340). The computer-readable medium 322 may also be used for storing data that is manipulated by the processor 320 when executing the software.

The camera module 302 may obtain images via different cameras, such as a first camera 304 and a second camera 306. The first camera 304 and the second camera 306 may be a vision sensors (e.g., a stereoscopic camera or a red-green-blue (RGB) camera) for capturing 2D RGB images. Alternatively, the camera module may be coupled to a ranging sensor, such as a light detection and ranging (LIDAR) sensor or a radio detection and ranging (RADAR) sensor. Of course, aspects of the present disclosure are not limited to the aforementioned sensors, as other types of sensors (e.g., thermal, sonar, and/or lasers) are also contemplated for either of the first camera 304 or the second camera 306.

The images of the first camera 304 and/or the second camera 306 may be processed by the processor 320, the camera module 302, the robot perception module 310, the communication module 324, the locomotion module 326, the location module 328, and the controller module 340. In conjunction with the computer-readable medium 322, the images from the first camera 304 and/or the second camera 306 are processed to implement the functionality described herein. In one configuration, detected 3D object information captured by the first camera 304 and/or the second camera 306 may be transmitted via the transceiver 332. The first camera 304 and the second camera 306 may be coupled to the robot 350 or may be in communication with the robot 350.

Capturing, modeling, and synthesizing realistic human motion in 3D scenes is important in a spectrum of applications such as virtual reality, game character animation, and human-robot interaction. To facilitate research in this area, a plethora of datasets have been curated to capture human motion. For example, collections of trajectories of human manipulating objects as well as datasets containing human contact with a scene mesh with object class labels are available. Nevertheless, building high-quality large-scale datasets annotated by both diverse human motions and reconstruction of a wide variety of 3D scenes still remains challenging. This is mainly because such data is captured in laboratory settings, which entails limited physical space and costly devices, such as motion capture systems, structure cameras, and a 3D scan system. A process of leveraging recent advances in modeling 3D human poses and their contacts with environments to synthesize the scenes from human motion data, is desired.

The location module 328 may determine a location of the robot 350. For example, the location module 328 may use a global positioning system (GPS) to determine the location of the robot 350. The location module 328 may implement a dedicated short-range communication (DSRC)-compliant GPS unit. A DSRC-compliant GPS unit includes hardware and software to make the robot 350 and/or the location module 328 compliant with one or more of the following DSRC standards, including any derivative or fork thereof: EN 12253:2004 Dedicated Short-Range Communication—Physical layer using microwave at 5.9 GHz (review); EN 12795:2002 Dedicated Short-Range Communication (DSRC)—DSRC Data link layer: Medium Access and Logical Link Control (review); EN 12834:2002 Dedicated Short-Range Communication—Application layer (review); EN 13372:2004 Dedicated Short-Range Communication (DSRC)—DSRC profiles for RTTT applications (review); and EN ISO 14906:2004 Electronic Fee Collection—Application interface.

A DSRC-compliant GPS unit within the location module 328 is operable to provide GPS data describing the location of the robot 350 with space-level accuracy for accurately directing the robot 350 to a desired location. For example, the robot 350 is moving to a predetermined location and desires partial sensor data. Space-level accuracy means the location of the robot 350 is described by the GPS data sufficient to confirm a location of the robot 350 parking space. That is, the location of the robot 350 is accurately determined with space-level accuracy based on the GPS data from the robot 350.

The communication module 324 may facilitate communications via the transceiver 332. For example, the communication module 324 may be configured to provide communication capabilities via different wireless protocols, such as Wi-Fi, long term evolution (LTE), 3G, etc. The communication module 324 may also communicate with other components of the robot 350 that are not modules of the scene synthesis from human motion system 300. The transceiver 332 may be a communications channel through a network access point 360. The communications channel may include DSRC, LTE, LTE-D2D, mmWave, Wi-Fi (infrastructure mode), Wi-Fi (ad-hoc mode), visible light communication, TV white space communication, satellite communication, full-duplex wireless communications, or any other wireless communications protocol such as those mentioned herein.

In some configurations, the network access point 360 includes Bluetooth ® communication networks or a cellular communications network for sending and receiving data, including via short messaging service (SMS), multimedia messaging service (MMS), hypertext transfer protocol (HTTP), direct data connection, wireless application protocol (WAP), e-mail, DSRC, full-duplex wireless communications, mmWave, Wi-Fi (infrastructure mode), Wi-Fi (ad-hoc mode), visible light communication, TV white space communication, and satellite communication. The network access point 360 may also include a mobile data network that may include 3G, 4G, 5G, LTE, LTE-V2X, LTE-D2D, VoLTE, or any other mobile data network or combination of mobile data networks. Further, the network access point 360 may include one or more IEEE 802.11 wireless networks.

The scene synthesis from human motion system 300 also includes the planner module 330 for planning a selected trajectory to perform a route/action (e.g., collision avoidance) of the robot 350 and the controller module 340 to control the locomotion of the robot 350. The controller module 340 may perform the selected action via the locomotion module 326 for autonomous operation of the robot 350 along, for example, a selected route. In one configuration, the planner module 330 and the controller module 340 may collectively override a user input when the user input is expected (e.g., predicted) to cause a collision according to an autonomous level of the robot 350. The modules may be software modules running in the processor 320, resident/stored in the computer-readable medium 322, and/or hardware modules coupled to the processor 320, or some combination thereof

The National Highway Traffic Safety Administration (NHTSA) has defined different “levels” of autonomous agents (e.g., Level 0, Level 1, Level 2, Level 3, Level 4, and Level 5). For example, if an autonomous agent has a higher-level number than another autonomous agent (e.g., Level 3 is a higher-level number than Levels 2 or 1), then the autonomous agent with a higher-level number offers a greater combination and quantity of autonomous features relative to the agent with the lower-level number. These distinct levels of autonomous agents are described briefly below.

Level 0: In a Level 0 agent, the set of advanced driver assistance system (ADAS) features installed in an agent provide no agent control but may issue warnings to the driver of the agent. An agent which is Level 0 is not an autonomous or semi-autonomous agent.

Level 1: In a Level 1 agent, the driver is ready to take operation control of the autonomous agent at any time. The set of ADAS features installed in the autonomous agent may provide autonomous features such as: adaptive cruise control (ACC); parking assistance with automated steering; and lane keeping assistance (LKA) type II, in any combination.

Level 2: In a Level 2 agent, the driver is obliged to detect objects and events in the roadway environment and respond if the set of ADAS features installed in the autonomous agent fail to respond properly (based on the driver's subjective judgement). The set of ADAS features installed in the autonomous agent may include accelerating, braking, and steering. In a Level 2 agent, the set of ADAS features installed in the autonomous agent can deactivate immediately upon takeover by the driver.

Level 3: In a Level 3 ADAS agent, within known, limited environments (such as freeways), the driver can safely turn their attention away from operation tasks but must still be prepared to take control of the autonomous agent when needed.

Level 4: In a Level 4 agent, the set of ADAS features installed in the autonomous agent can control the autonomous agent in all but a few environments, such as severe weather. The driver of the Level 4 agent enables the automated system (which is comprised of the set of ADAS features installed in the agent) only when it is safe to do so. When the automated Level 4 agent is enabled, driver attention is not required for the autonomous agent to operate safely and consistent within accepted norms.

Level 5: In a Level 5 agent, other than setting the destination and starting the system, no human intervention is involved. The automated system can drive to any location where it is legal to drive and make its own decision (which may vary based on the district where the agent is located).

A highly autonomous agent (HAA) is an autonomous agent that is Level 3 or higher. Accordingly, in some configurations the robot 350 is one of the following: a Level 0 non-autonomous agent; a Level 1 autonomous agent; a Level 2 autonomous agent; a Level 3 autonomous agent; a Level 4 autonomous agent; a Level 5 autonomous agent; and an HAA.

The robot perception module 310 may be in communication with the camera module 302, the processor 320, the computer-readable medium 322, the communication module 324, the locomotion module 326, the location module 328, the planner module 330, the transceiver 332, and the controller module 340. In one configuration, the robot perception module 310 receives sensor data from the camera module 302. The camera module 302 may receive RGB video image data from the first camera 304 and the second camera 306. According to aspects of the present disclosure, the robot perception module 310 may receive RGB video image data directly from the first camera 304 or the second camera 306 to perform placement of unseen objects from images captured by the first camera 304 and the second camera 306 of the robot 350.

As shown in FIG. 3, the robot perception module 310 includes a 3D human pose trajectory module 312, a contact label generation module 314, a contact point estimation module 316, and a 3D object placement module 318. The 3D human pose trajectory module 312, the contact label generation module 314, the contact point estimation module 316, and the 3D object placement module 318 may be components of a same or different artificial neural network, such as a convolutional neural network (CNN). The modules (e.g., 312, 314, 316, 318) of the robot perception module 310 are not limited to a convolutional neural network. In operation, the robot perception module 310 receives a video stream from the first camera 304 and the second camera 306. The video stream may include a 2D RGB left image from the first camera 304 and a 2D RGB right image from the second camera 306 to provide a stereo pair of video frame images. The video stream may include multiple frames, such as image frames.

In some aspects of the present disclosure, the robot perception module 310 is configured to understand a scene from a video input (e.g., the camera module 302) based on placement of objects within a scene as a perception task during autonomous operation of the robot 350. Aspects of the present disclosure are directed to a method for scene synthesis from human motion, including computing, by the 3D human pose trajectory module 312, three-dimensional (3D) human pose trajectories of human motion in a scene. Once computed, the contact label generation module 314 generates contact labels of unseen objects in the scene based on the computing of the 3D human pose trajectories.

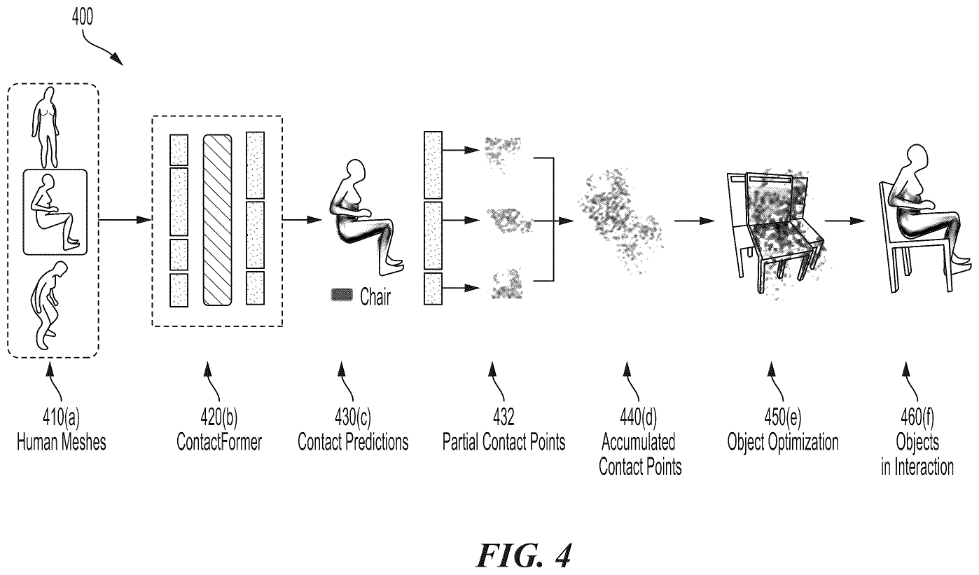

In some aspects of the present disclosure, the contact point estimation module 316 estimates contact points between human body vertices of the 3D human pose trajectories and the contact labels of the unseen objects that are in contact with the human body vertices. In response, the 3D object placement module 318 predicts object placements of the unseen objects in the scene based on the estimated contact points. Large-scale capture of human motion with diverse, complex scenes, while immensely useful, is often considered prohibitively costly. Meanwhile, human motion alone contains rich information about the scene they reside in and interact with. For example, from a sitting human, we can infer the existence of a chair, and further deduce the pose of the chair from leg positions using a process shown, for example, in FIGS. 4A-4F.

### 1. Summon Process

FIGS. 4A-4F illustrate a scene synthesis from human motion (SUMMON) process 400 performed using solely human motion, according to aspects of the present disclosure. Various aspects of the present disclosure are directed to the SUMMON process 400 in which a set of furniture objects and a physically plausible 3D configuration of the furniture objects are predicted solely from human motion sequences. For example, this process first introduces the human body and contact representation (see Sec. 1.1). The SUMMON process 400 generates a temporally consistent contact semantic estimation for each vertex of the human body to retrieve suitable objects (see Sec. 1.2). Then the SUMMON process 400 optimizes object placement based on the contact locations and physical plausibility (see Sec. 1.3), such as objects fitting contact points.

### 1.1 Human Body and Contact Representation

FIG. 4A illustrates human meshes 410 to provide a representation for human body poses. In this example, an input sequence of the human meshes 410 interacting with the scene are based on a parameterization of the human body with M(θβ): [symbol] ^{|θ|×|β|}→ [symbol] ^{3N} where θ denotes pose parameters, β denotes coefficients in a learned shape space, and N is the number of vertices in the human meshes 410. For computation efficiency, the vertices are downsampled from 10,475 to 655 points.

This example represents contact information by per-vertex features. For each vertex v_{b}∈V_{b}, where V_{b} is all vertices of a human body, the human meshes 410 use a one-hot vector f to represent the contact semantic label for that vertex. Each vector f has a length of |f|=C+1, where C is the number of object classes. The human meshes 410 introduce an extra “void” class to represent vertices without contact. Additionally, F is used to denote the contact semantic labels for all the vertices in a body pose.

### 1.2 Human-Scene Contact Prediction

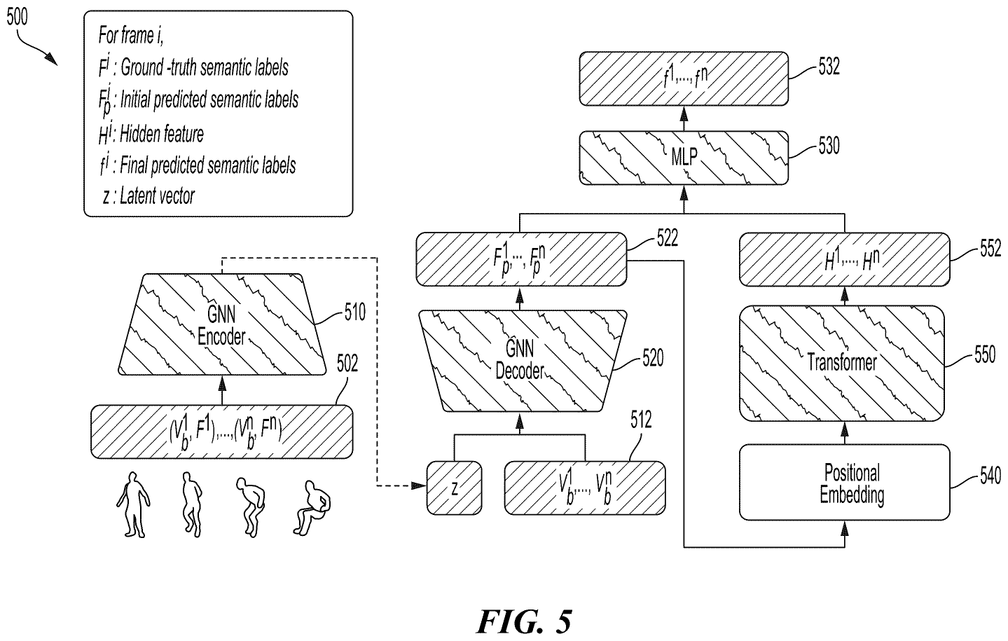

FIG. 4B illustrates a contact former 420 that predicts contact labels, which is further illustrated in FIG. 5. FIG. 5 is a block diagram of a contact former architecture 500 for the scene synthesis from human motion system of FIG. 4B, according to aspects of the present disclosure.

As shown in FIG. 5, an input data 502 consists of a sequence of paired vertices and contact semantic labels {(V_{b}¹, F¹), (V_{b}², F²), . . . , (V_{b}ⁿ, Fⁿ)}, where V_{b}¹ represents the human body vertices of the human meshes 410 of FIG. 4A, F¹ 532 represents the contact semantic labels for frame i and n is the varied sequence length. In this example, the contact former architecture 500 first trains a conditional variational autoencoder (cVAE) of a graph neural network (GNN) encoder 510 to learn a probabilistic model of contact semantic labels conditioned on vertex positions. Then transformer layers are deployed on top of the GNN encoder 510 to improve temporal consistency. As shown in FIG. 5, the contract former architecture 500 uses a GNN-based encoder (e.g., the cVAE of the GNN encoder 510) to provide encoded contact points 512. Additionally, the GNN decoder 520 provides semantic labels 522. Next, a transformer is applied to improve the temporal information fusion. Additionally, a sinusoidal positional embedding 540 is added to the output of the GNN decoder 520 and a multilayer perceptron (MLP) 530.

Contact semantics prediction. Various aspects of the present disclosure first train a model to predict contact semantic labels for each individual pose. Given a pair of pose and contact semantic labels (V_{b}, F), these two components are first fused: Iₑ=Concat(V_{b}, F). Additionally, Iₑ is fed into a graph neural network (GNN) encoder G_{Enc} to get a latent Gaussian space with the mean H_{μ} and the standard deviation H_{σ}. Then a latent vector z is sampled from the latent Gaussian space and concatenated with each vertex position: I_{d}=Concat(V_{b}, z). Next, I_{d} is feed into a GNN decoder G_{Dec} to predict the reconstructed contact semantic labels Fₚ. Each vertex feature hₓ^{k} for vertex x at layer k is updated by:

hₓ^{k}=Linear(Concat({hₓ^{k-1}: x′∈N(x)})) (1)

where N(x) is defined as the m-nearest neighbor vertices of x in the space.

ContactFormer: A transformer module 550 is trained to extract temporal information for a pose sequence to enhance prediction consistency as shown in FIG. 5. Specifically, given a sequence of pose and contact semantic labels {(V_{b}¹, F¹), . . . , (V_{b}ⁿ, Fⁿ)} from frame 1 to n, a previous model is first used to reconstruct contact semantic labels Fₚⁱ independently for each frame i. Each Fₚⁱ is then embedded into a hidden feature, augmenting it with a sinusoidal positional embedding 540 before feeding it to the transformer module 550. The output 552 of the transformer module 550 is a sequence of n vectors {H₁, . . . , Hₙ}. For each frame i, H₁ is concatenated with the prediction from \hat{F}ₚⁱ. The final prediction is shown as contract predictions 430 in FIG. 4C.

Training: Some aspects of the present disclosure optimize the model's parameters by the following loss function:

[symbol]

= [symbol] _{rec}+α· [symbol] _{KL}, (2)

where [symbol] _{rec} is the sum of the categorical cross entropy (CCE) loss between the ground truth semantic label Fⁱ and the model prediction \hat{F}ⁱ for any frame i:

$${ℒ}_{rec} = {\sum }_{i} CCE ( {F}^{i} , {\hat{F}}^{i} ) , \qquad ( 3 )$$

and [symbol] _{KL} is the Kullback-Leibler divergence loss between the latent Gaussian space and the normal distribution [symbol] :

[symbol]

_{KL}=KL(Q(z|F, V_{b})∥ [symbol] ). (4)

In this example, Q represents the encoder network in the cVAE of the GNN encoder 510, combined with the sampling process with the reparameterization trick. Additionally, [symbol] _{KL} is multiplied with a weight α to control the balance between the reconstruction accuracy and diversity.

### 1.3 Scene Synthesis

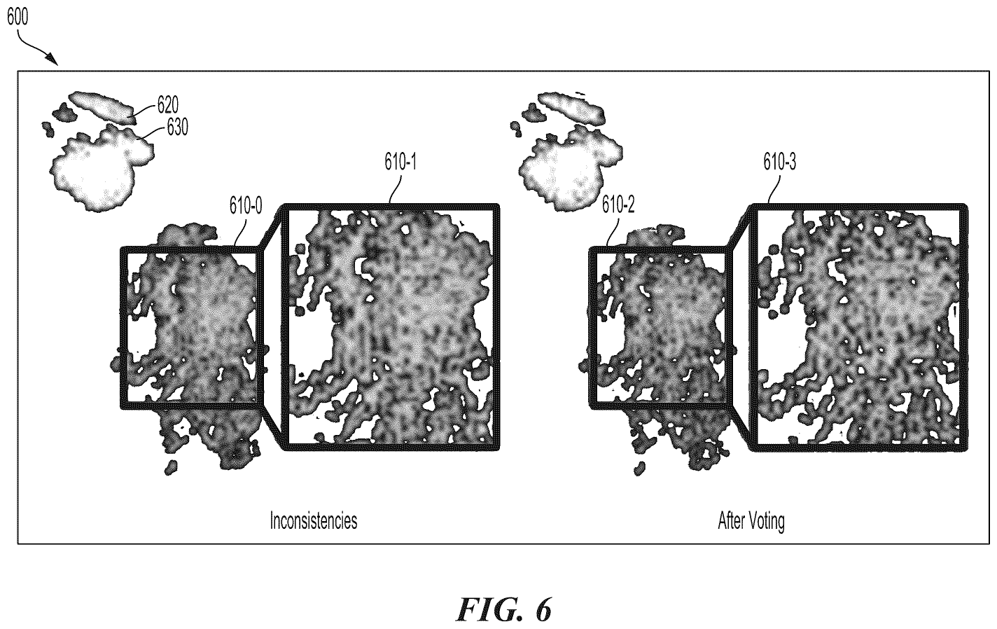

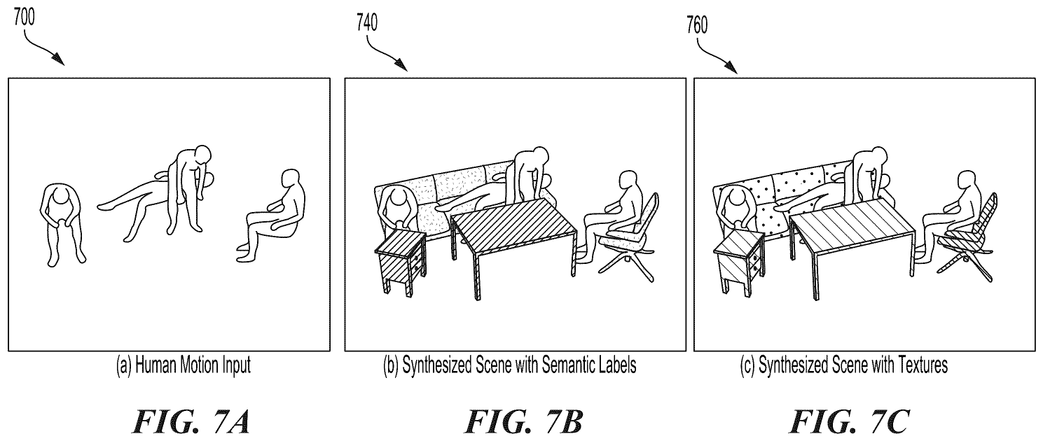

Contact Object Recovery. Given the predicted per-vertex contact labels, shown as accumulated contact points 440 in FIG. 4D, spatial prediction noise is further reduced by performing a local object class majority voting as shown in FIG. 6. FIG. 6 is a diagram illustrating majority voting to enable scene synthesis from human motion, according to aspects of the present disclosure. As shown in the zoomed-in boxes 610 (610-0, 610-1, 610-2, 610-3), there are multiple inconsistent points in the original contact points. The first points 620 represent a semantic label bed, and the second points 630 represent a sofa. The issue shown in FIG. 7 is alleviated by adding majority voting.

As shown in FIG. 4D, the vertices of each predicted object class are clustered into contact instances V_{c}. In practice, the contact vertices are downsampled to keep later computations tractable.

Next the poses of the object point cloud Vₒ are optimized by minimizing the following losses:

[symbol]

(V_{c}, Vₒ)= [symbol] _{contact}+ [symbol] ₚₑₙ. (5)

The contact loss [symbol] _{contact} is defined as:

$${ℒ}_{contact} = {λ}_{contact} \frac{1}{\vert {V}_{c} \vert} {\sum }_{{v}_{c} ∈ {V}_{c}} {min}_{{v}_{o} ∈ {V}_{o}} {‖ {v}_{c} - {v}_{o} ‖}_{2}^{2} , \qquad ( 6 )$$

where λ_{contact} is a tunable hyperparameter. This loss encourages the object to be in contact with the predicted human vertices. The penetration loss [symbol] ₚₑₙ is defined as the squared distances of object points that penetrate the human body sequence:

$${ℒ}_{pen} = {λ}_{pen} {\sum }_{{d}_{c}^{i} < t} {d}_{c}^{{i}^{2}} , \qquad ( 7 )$$

where d_{c}ⁱ are signed distances between the object and the human body sequence, t is the penetration distance threshold. This loss prevents the object from penetrating the human body sequence.

Intuitively, these losses encourage objects to be in contact with human meshes, but not penetrate them. An illustration of the object optimization 450 placement is shown in FIG. 4E. To improve computation efficiency, the human signed distance field (SDF) is computed from merged human meshes of the contact sequence. To have a consistent scale of loss across different objects, the number of sampled points is selected according to the size of the object.

Constrained Scene Completion. To obtain a complete scene, non-contact objects are predicted as a scene completion task constrained by 3D human trajectories and existing in-contact objects. The floor is divided into a grid and each cell is labeled as occupied if feet vertices or object vertices are in close proximity. Additionally, a probabilistic autoregressive model is learned for missing object prediction in a partial 3D scene. The inputs are existing object classes. The model first outputs a distribution of object classes from which the class of the next object is sampled. An instance is then randomly sampled from that class to be placed into a random unoccupied floor grid. To prevent the sampled object from penetrating the human body sequence, the object's translation and rotation is further optimized using [symbol] ₚₑₙ (see Equation 7).

FIGS. 7A-7C illustrate a scene synthesis using the scene synthesis from human motion (SUMMON) process of FIGS. 4A-4F and the contact former architecture of FIG. 5, according to aspects of the present disclosure. FIG. 7A illustrates a human motion input 700 from a human motion sequence. FIG. 7B illustrates a synthesized scene with semantic labels 740. FIG. 7C illustrates a synthesized scene with textures 760.

Referring again to the contact former architecture of FIG. 5, in one configuration the number of hidden layers selected for the GNN encoder 510 and the GNN decoder 520 is three (3) hidden layers. Additionally, a dimension for each hidden vertex feature in the GNN encoder 510 and the GNN decoder 520 is selected as sixty-four (64) dimensions. In the GNN encoder 510, after each hidden layer, the body vertices are downsampled by a factor of four (4). For the transformer layers of the transformer module 550, each layer is split into a multi-head attention layer and a position-wise feed forward layer. In some configurations, both the attention layer and the feed forward layer have a residual addition. For both a transformer encoder block and a decoder block, the number of layers is set to three (3) and the number of heads is set to four (4).

For the model that uses the MLP module 530, a max pooling layer is deployed to the output the semantic labels 522 from the GNN decoder 520 along the dimension of vertices, which is then feed to the MLP module 530 to get the embedding for the whole sequence. The sequence embedding is then fused with the semantic labels 522 output from the GNN decoder 520 to provide a final prediction via a linear projection. In a model that uses a long-short term memory (LSTM) module, the outputs are linearly projected from the GNN decoder 520 into a higher dimensional embedding space and fed to a bidirectional LSTM layer to extract features for each frame. Frame features are then concatenated with the semantic labels 522 output from the GNN decoder 520 to obtain final semantic labels.

Referring again to FIG. 6, contact object recovery is performed by reducing noises in contact semantic estimation by using majority semantic voting in point cloud clusters with ∈=0.1 and minPts=10. In point cloud clustering for object instance fitting, different values for E are used for different classes due to their varied sizes.

To place objects into the scene with appropriate height, the floor height is first estimated by calculating a minimum of medians among all the floor-contacting clusters with ∈=0.005 and minPts=3. Then the object is translated to place its lowest vertex on the floor.

To avoid local minima, a grid search is performed for translation along the floor plane and rotation around the up axis to warm start the initial transformation. Additionally, different [symbol] _{contact}, [symbol] ₚₑₙ, and t are used for different object classes in the loss function to accommodate for different properties of object classes. For example, beds and sofas are softer objects and should have more tolerance for penetrations. The translation is then optimized along the floor plane and rotation around the up axis on top of best transformation from grid search, with different λ_{contact}, λₚₑₙ, and t for different object classes in the loss function.

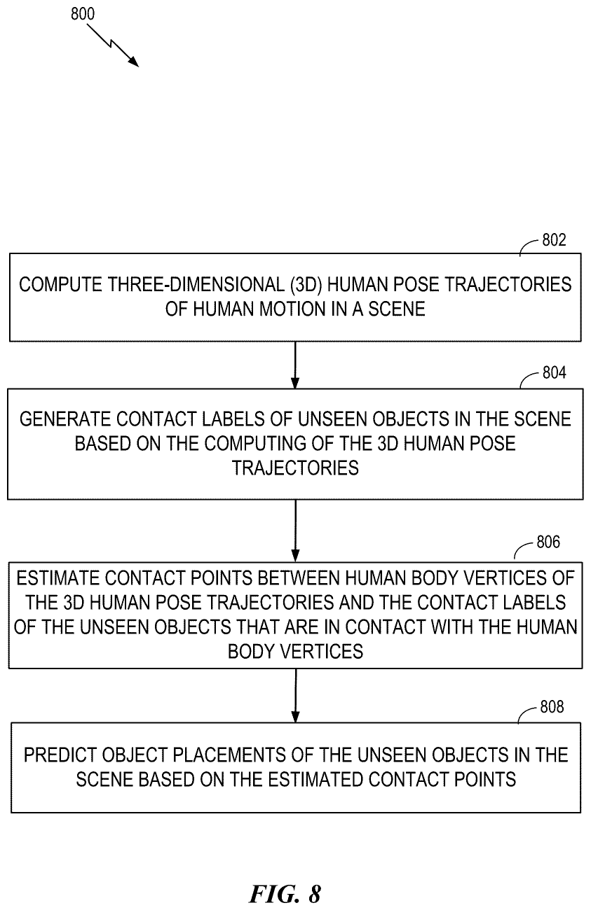

To achieve scene diversity, inter-class and intra-class diversity are considered. Inter-class diversity is when a human motion is likely to interact with different classes of objects. For example, the motion of sitting down can be performed on a chair, a bed, or a sofa. To achieve this, first per-vertex contact semantics are sample based on a predicted contact probability distribution from ContactFormer. During local clustering of contact object recovery, class labels are considered in the local clusters as a probability distribution and sample the cluster contact class. Intra-class diversity is when a human motion is likely to interact with different instances of the same object class. To achieve this, grid search is performed and optimization on all the instances from the object class. A process for scene synthesis from human motion is further illustrated, for example, in FIG. 8.

FIG. 8 is a flowchart illustrating a method for scene synthesis from human motion, according to aspects of the present disclosure. A method 800 begins at block 802, in which three-dimensional (3D) human pose trajectories of human motion in a scene are computed. For example, as shown in FIG. 3, In some aspects of the present disclosure, the robot perception module 310 is configured to understand a scene from a video input (e.g., the camera module 302) based on placement of objects within a scene as a perception task during autonomous operation of the robot 350. Aspects of the present disclosure are directed to a method for scene synthesis from human motion, including computing, by the 3D human pose trajectory module 312, three-dimensional (3D) human pose trajectories of human motion in a scene.

At block 804, contact labels of unseen objects in the scene are generated based on the computing of the 3D human pose trajectories. For example, as shown in FIG. 3, the contact label generation module 314 generates contact labels of unseen objects in the scene based on the computing of the 3D human pose trajectories. Additionally, FIG. 4B illustrates the contact former 420 that predicts contact labels, which is further illustrated in FIG. 5, as a contact former architecture 500 for the scene synthesis from human motion system of FIG. 4B, according to aspects of the present disclosure.

At block 806, contact points are estimated between human body vertices of the 3D human pose trajectories and the contact labels of the unseen objects that are in contact with the human body vertices. For example, as shown in FIG. 3, the contact point estimation module 316 estimates contact points between human body vertices of the 3D human pose trajectories and the contact labels of the unseen objects that are in contact with the human body vertices. Additionally, FIGS. 4A-4F illustrate the SUMMON process 400 performed using solely human motion, according to aspects of the present disclosure. According to the SUMMON process 400, a set of furniture objects and a physically plausible 3D configuration of the furniture objects are predicted solely from human motion sequences. For example, this process first introduces the human body and contact representation (see Sec. 1.1). The SUMMON process 400 generates a temporally consistent contact semantic estimation for each vertex of the human body to retrieve suitable objects (see Sec. 1.2). Then the SUMMON process 400 optimizes object placement based on the contact locations and physical plausibility (see Sec. 1.3), such as objects fitting contact points.

At block 808, object placements are predicted for the unseen objects in the scene based on the estimated contact points. For example, as shown in FIG. 3, the 3D object placement module 318 predicts object placements of the unseen objects in the scene based on the estimated contact points. Large-scale capture of human motion with diverse, complex scenes, while immensely useful, is often considered prohibitively costly. Meanwhile, human motion alone contains rich information about the scene they reside in and interact with. For example, from a sifting human, we can infer the existence of a chair, and further deduce the pose of the chair from leg positions using a process shown, for example, in FIGS. 4A-4F.

In some aspects of the present disclosure, the method 800 may be performed by the SOC 100 (FIG. 1) or the software architecture 200 (FIG. 2) of the robot 150 (FIG. 1). That is, each of the elements of method 800 may, for example, but without limitation, be performed by the SOC 100, the software architecture 200, or the processor (e.g., CPU 102) and/or other components included therein of the robot 150.

The various operations of methods described above may be performed by any suitable means capable of performing the corresponding functions. The means may include various hardware and/or software component(s) and/or module(s), including, but not limited to, a circuit, an application-specific integrated circuit (ASIC), or processor. Where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Additionally, “determining” may include receiving (e.g., receiving information), accessing (e.g., accessing data in a memory), and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules, and circuits described in connection with the present disclosure may be implemented or performed with a processor configured according to the present disclosure, a digital signal processor (DSP), an ASIC, a field-programmable gate array signal (FPGA) or other programmable logic device (PLD), discrete gate or transistor logic, discrete hardware components, or any combination thereof designed to perform the functions described herein. The processor may be a microprocessor, but in the alternative, the processor may be any commercially available processor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media may include random access memory (RAM), read-only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may connect a network adapter, among other things, to the processing system via the bus. The network adapter may implement signal processing functions. For certain aspects, a user interface (e.g., keypad, display, mouse, joystick, etc.) may also be connected to the bus. The bus may also link various other circuits, such as timing sources, peripherals, voltage regulators, power management circuits, and the like, which are well known in the art, and therefore, will not be described any further.

The processor may be responsible for managing the bus and processing, including the execution of software stored on the machine-readable media. Examples of processors that may be specially configured according to the present disclosure include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read-only memory (ROM), programmable read-only memory (PROM), erasable programmable read-only memory (EPROM), electrically erasable programmable read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in numerous ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an ASIC with the processor, the bus interface, the user interface, supporting circuitry, and at least a portion of the machine-readable media integrated into a single chip, or with one or more PGAs, PLDs, controllers, state machines, gated logic, discrete hardware components, or any other suitable circuitry, or any combination of circuits that can perform the various functions described throughout the present disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media, including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc; where disks usually reproduce data magnetically, while discs reproduce data optically with lasers. Thus, in some aspects computer-readable media may comprise non-transitory computer-readable media (e.g., tangible media). In addition, for other aspects, computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for scene synthesis from human motion, comprising:
computing three-dimensional (3D) human pose trajectories of human motion in a scene;
generating contact labels of unseen objects in the scene based on the computing of the 3D human pose trajectories;
estimating contact points between human body vertices of the 3D human pose trajectories and the contact labels of the unseen objects that are in contact with the human body vertices; and
predicting object placements of the unseen objects in the scene based on the estimated contact points.

2. The method of claim 1, in which obtaining contact labels further comprises incorporating temporal cues to enhance a consistency in label prediction of the contact labels.

3. The method of claim 1, in which estimating contact points further comprises training a contact model to learn a mapping from the human body vertices of the 3D human pose trajectories to the contact labels of contacted objects.

4. The method of claim 1, in which predicting the object placements comprises searching for objects fitting contact points using semantics and physical affordances to an agent.

5. The method of claim 4, further comprising populating the scene with other objects that have no contact with humans, based on human motion and objects inferred from previous operations.

6. A system for scene synthesis from human motion, comprising:
a pose trajectory module to compute three-dimensional (3D) pose trajectories of human motion; and
a prediction module for a human-scene contact and scene synthesis, configured to predict a feasible object placement in a scene based on the computed 3D pose trajectories of human motion.

7. The system of claim 6, in which the system incorporates temporal cues to enhance a consistency in label prediction.

8. The system of claim 6, further comprising a contact module to leverages existing, human-scene interaction (HSI) data, and to learn a mapping from body vertices to semantic labels of objects that are in contact.

9. The system of claim 6, further comprising an object model trained to predict objects fitting contact points using semantics and physical affordances to an agent.

10. The system of claim 6, further comprising a 3D object placement module to populate the scene with other objects that have no contact with humans, based on human motion and objects inferred from previous operations.

11. A non-transitory computer-readable medium having program code recorded thereon for scene synthesis from human motion, the program code being executed by a processor and comprising:
program code to compute three-dimensional (3D) human pose trajectories of human motion in a scene;
program code to generate contact labels of unseen objects in the scene based on the computing of the 3D human pose trajectories;
program code to estimate contact points between human body vertices of the 3D human pose trajectories and the contact labels of the unseen objects that are in contact with the human body vertices; and
program code to predict object placements of the unseen objects in the scene based on the estimated contact points.

12. The non-transitory computer-readable medium of claim 11, in which the program code to obtain contact labels further comprises program code to incorporate temporal cues to enhance a consistency in label prediction of the contact labels.

13. The non-transitory computer-readable medium of claim 11, in which the program code to estimate contact points further comprises program code to train a contact model to learn a mapping from the human body vertices of the 3D human pose trajectories to the contact labels of contacted objects.

14. The non-transitory computer-readable medium of claim 11, in which the program code to predict the object placements comprises program code to search for objects fitting contact points using semantics and physical affordances to an agent.

15. The non-transitory computer-readable medium of claim 14, further comprising program code to populate the scene with other objects that have no contact with humans, based on human motion and objects inferred from previous operations.

16. A system for scene synthesis from human motion, the system comprising:
a three-dimensional (3D) human pose trajectory module to compute 3D human pose trajectories of human motion in a scene;
a contact label generation module to generate contact labels of unseen objects in the scene based on the computing of the 3D human pose trajectories;
a contact point estimation module to estimate contact points between human body vertices of the 3D human pose trajectories and the contact labels of the unseen objects that are in contact with the human body vertices; and
a 3D object placement module to predict object placements of the unseen objects in the scene based on the estimated contact points.

17. The system of claim 16, in which the contact label generation module is further to incorporate temporal cues to enhance a consistency in label prediction of the contact labels.

18. The system of claim 16, in which the contact point estimation module is further to train a contact model to learn a mapping from the human body vertices of the 3D human pose trajectories to the contact labels of contacted objects.

19. The system of claim 16, in which the 3D object placement module is further to search for objects fitting contact points using semantics and physical affordances to an agent.

20. The system of claim 19, in which the 3D object placement module is further to populate the scene with other objects that have no contact with humans, based on human motion and objects inferred from previous operations.
